(19) United States
(12) Patent Application Publication
(10) Pub. No.: US 2006/0130124 A1
(43) Pub. Date: Jun. 15, 2006

(54) A Remote Communication System and Method Implementing a Session Server and One or More Object Servers

(75) Inventors: John H. Richardson, Wilkes-Barre, PA (US); Carl J. Witkowski, Duryea, PA (US)

Correspondence Address: LACASSE & ASSOCIATES, LLC, 1725 DUKE STREET, SUITE 650, ALEXANDRIA, VA, 22314, US

(73) Assignee: GUARD INSURANCE GROUP, Wilkes-Barre, PA (US)

(21) Appl. No.: 10/905,102

(22) Filed: Dec. 15, 2004

(51) Int. Cl. H04L 9/32

(52) U.S. Cl. 726/3

(57) ABSTRACT

A system and method implemented using a session server and one or more object servers allows an individual to provide input at a client terminal and perform server-speed processing of electronic insurance documents at the server rather than the client. The session server loads at least one software module among a plurality of modules to communicate with at least one object server, and the session server monitors at least one client session environment via the loaded software module. The session server reflects modified client environment(s) to at least one object server, wherein processing associated with the communication session is effected based on the reflected modified client environment(s) and the communication between the session server and corresponding object server.

### BACKGROUND OF THE INVENTION

The present invention relates generally to the field of remote processing and remote access solutions. More specifically, the present invention is related to remote communications via a session server and one or more object servers, each implementing one or more applications.

### DISCUSSION OF PRIOR ART

There are a myriad of prior art remote access solutions available such as Symantec PCAnywhere™ and GoToMyPC™ wherein users utilize specific remote access software to gain access to remote servers or PC's. FIGS. 1a-b illustrate two such prior art remote access schemes. In a first scheme, depicted in FIG. 1a, users (such as user 102) interested in gaining remote access to a remote server 110 first install server-specific remote access software (such as a java script 104 or ActiveX component 106) on his/her personal computer (PC) 108. Next, using the installed server-specific remote access software, users access the remotely located server 110 over network 112 (e.g., local area network (LAN), wide area network (WAN), the Internet, etc.).

In a second scenario, depicted in FIG. 1b, users (such as user 114) who wish to remotely access their PC 116 install specific remote access software (such as java script 118 or ActiveX component 120) on the PC 116 that is to be remotely accessed. Next, user 114, or someone who is authorized to access PC 116 (such as a system administrator), is able to remotely access PC 116 over network 128 (e.g., local area network (LAN), wide area network (WAN), the Internet, etc.) after installing specific remote access software (such as a java script 122 or ActiveX component 124) via PC 126.

For example, users who are interested in remotely accessing their office PC 116 from a remote location install software such as Symantec's PCAnywhere™ software on their office PC 116. Next, users have to install a corresponding version of Symantec's PCAnywhere software in computer 126 from a remote location prior to being able to access the remotely located office PC (which should also be running the remote access software at the time access is requested).

A common aspect of prior art remote access solutions, such as one depicted in FIGS. 1a and 1b, is the necessity to install specific remote access software in a client PC prior to establishing communication with a remote server or remote PC, which also requires the pre-installation of remote access software.

The following patents provide general background regarding client/server interactions, but fail to overcome many of the limitations provided by the present invention.

The patent to Cavil (U.S. Pat. No. 6,003,069) provides for a client/server printer driver system. Cavil discloses a client terminal capable of submitting a job to a server, which processes the request and sends processed data to the client terminal. Additionally disclosed is a subsystem allowing a client terminal to send a portion of data to one or more servers and/or process a portion of data on the disclosed client itself. The disclosed subsystem is comprised of facilities to combine processed data from each of the different destinations to which the disclosed client terminal sent process requests.

The patent to Hare et al. (U.S. Pat. No. 6,625,641) provides for a method and apparatus for providing client support without installation of server software. Hare et al. disclose a client process executing on a local machine, having access to server software physically stored on a remote machine. When a client process has a request, a remote server software entry is located in a mount table entry. Once contact is made between a client and remote host, object services are provided to the disclosed client process. Also disclosed is a method of allowing a client process to locate an active server process at a remote host machine by utilizing the disclosed mount table entry. Processes are located and contacted on a remote host without user intervention.

The patent application publication to Mizutani (2003/0105813 A1) discloses a system and method for allowing client application processing requests to be processed on a server. A client-side I/O device is initialized based on information received from a server. The disclosed I/O device receives output information provided by the application-processing unit of the disclosed server in response to processing input information received from a client.

The Japanese patent to Asada (JP 9-204383) discloses a method of selecting and connecting to a server terminal with a light load. As a result of the disclosed selection process, applications executed on the server execute faster.

The Japanese patent to Wada et al. (JP 2003-30383) discloses a method connecting a client terminal to a data center storing requested rental software. The disclosed data center is also comprised of a form generation database allowing for client input. See abstract.

Whatever the precise merits, features, and advantages of the above cited references, none of them achieves or fulfills the purposes of the present invention.

### SUMMARY OF THE INVENTION

The present invention provides for a remote communication method implemented in a session server comprising the steps of: (a) establishing a communication session with a client; (b) loading at least one software application among a plurality of software applications to communicate with at least one object server; (c) monitoring one or more client session environments via a loaded software application; (d) reflecting modified client environment(s) to the object server, wherein processing associated with the communication session is effected based on reflected modified client environment(s) and communication between the session server and corresponding object server.

The present invention also provides for a communication system providing access to remotely controllable applications comprising: (a) one or more object servers, each object server associated with at least one remotely controllable application, with processing associated with said remotely controllable application affected by reflected modifications in client environments; (b) a session server storing one or more software modules, each software module capable of monitoring modifications to at least one client environment and communicating with at least one object server to reflect modifications; and said session server establishing a communication session with one or more clients, identifying at least one remotely controllable application associated with the communication session, loading a software module corresponding to identified remotely controllable application to communicate with corresponding object server, monitoring modifications to the client environment(s) via said loaded software module, and reflecting modifications in the client environment(s) to said corresponding object server.

The present invention also provides for an article of manufacture comprising a computer usable medium having computer readable program code embodied therein which implements each of the above-mentioned communication methods.

### BRIEF DESCRIPTION OF THE DRAWINGS

FIGS. 1a-b illustrate two prior art remote access schemes.

FIG. 2 illustrates an exemplary embodiment of the communication system of the present invention.

FIG. 3 illustrates an exemplary method of the present invention

FIG. 4 illustrates another embodiment of the present invention's communication method implemented in a session server for remote access to applications implemented in object servers, wherein each object server implements at least one application

FIGS. 5-15 illustrate various screenshots of one implementation of the present invention's system and method for remote access to applications implemented in object servers.

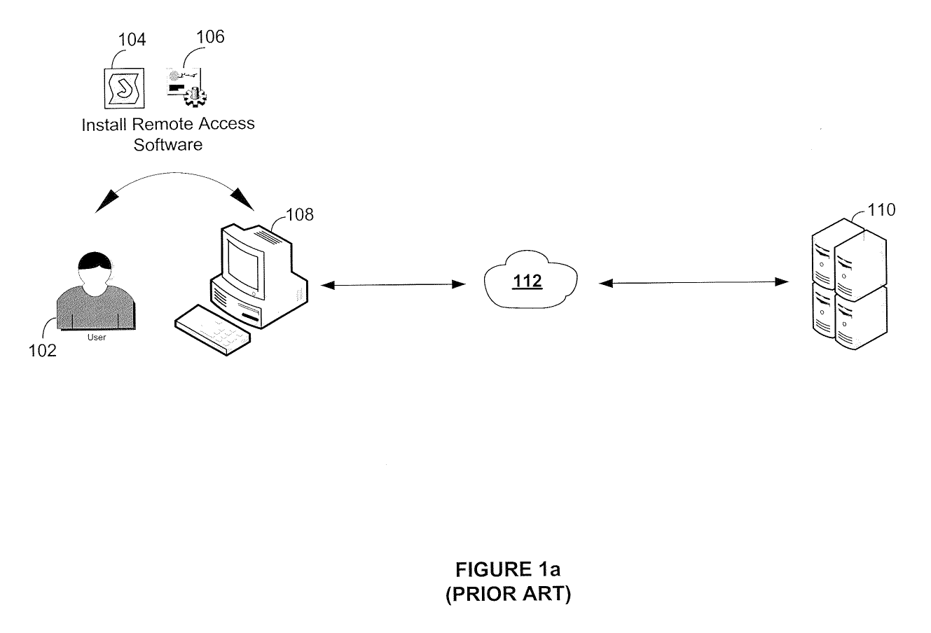

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

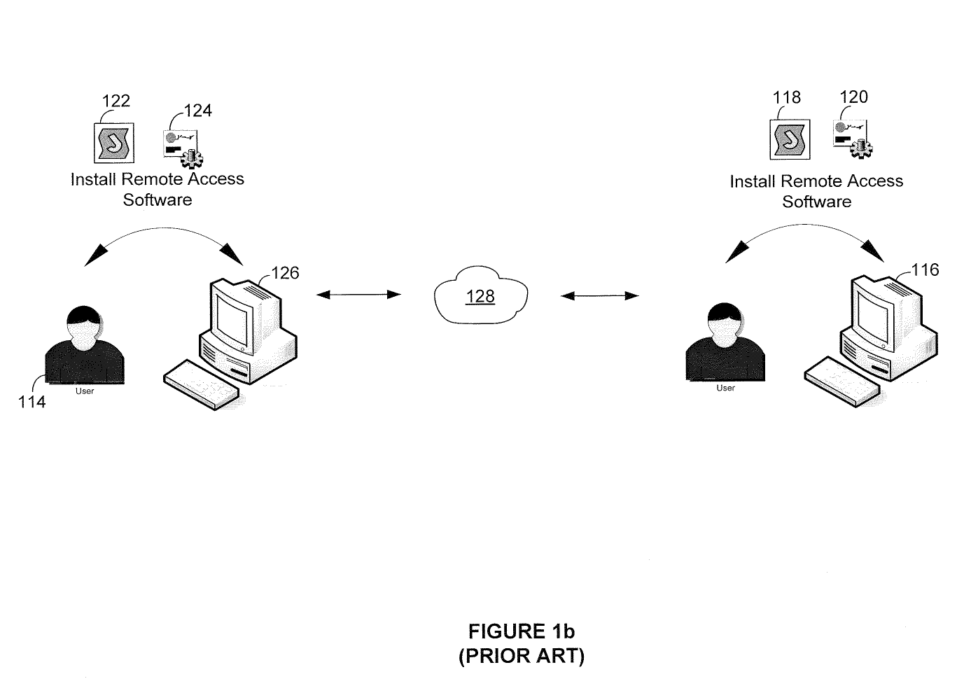

The present invention provides for a method and system for remote communication. FIG. 2 illustrates an exemplary embodiment of the communication system of the present invention. The present invention's communication system provides access to remotely controllable applications, wherein the system comprises a session server 202 and one or more object servers 204, 206, 208, and 210. Each object server is associated with at least one remotely controllable application, wherein processing associated with the remotely controllable application affected by reflected modifications in one or more client environment(s) (such as client environment(s) associated with client 200). Session server 202 stores one or more software modules, wherein each software module is capable of monitoring modifications to at least one client environment (such as client environment(s) associated with client 200) and communicating with at least one object server (204, 206, 208, or 210) to reflect such modifications. Session server 202 establishes a communication session with one or more clients (such as client 200), identifies at least one remotely controllable application associated with the communication session, loads a software module corresponding to identified remotely controllable application to communicate with corresponding object server (204, 206, 208, or 210), monitors modifications to client environment via the loaded software module, and reflects modifications in said client environment to said corresponding object server.

It should be noted that session server 202 and object server 204, 206, 208, or 210 does not have to be in the same premises, nor, the same segment of a network. They can be on a separate LAN, VAN, or WAN. Hence, the specific locations of the session server and the object servers should not be used to restrict the scope of the present invention.

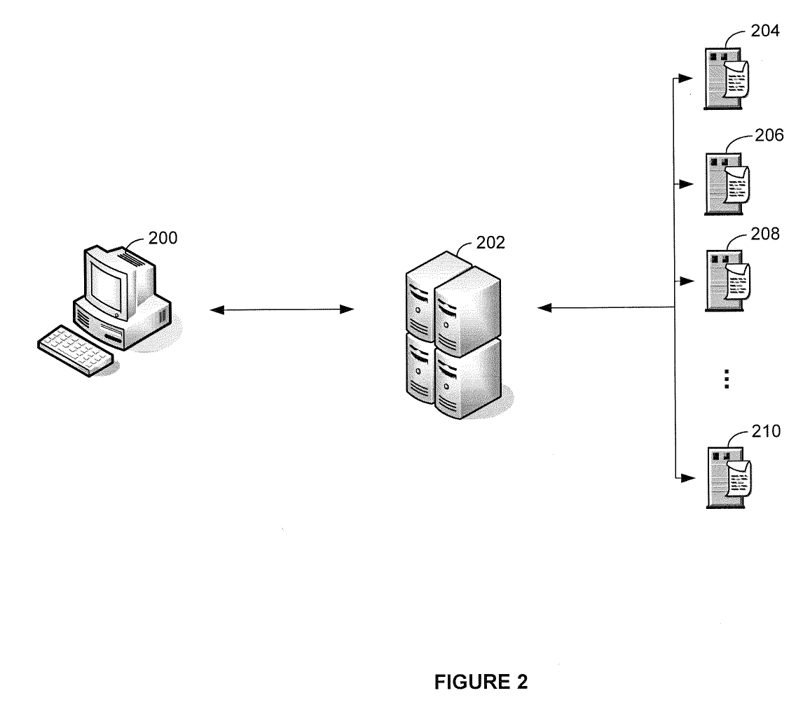

FIG. 3 illustrates exemplary method 300 of the present invention. In step 302, a communication session is established between a session server and a client. As one example, the communication session is established as a virtual private network (VPN) session. In the preferred embodiment, the client is a web browser (e.g., Internet Explorer™, Netscape™, Mozila™, etc.) and the session server is a terminal server. Also, in one embodiment, communications between the client and the session server is performed via the remote desktop protocol™ (RDP). It should be noted that communications between the client and the session server is over any of, or a combination of, the following networks: a local area network (LAN), a wide area network (WAN), or the Internet.

In step 304, the session server loads at least one software application among a plurality of software applications to communicate with at least one object server. Next, in step 306, the loaded software application monitors one or more client environment(s) to detect any changes in the client environment(s). In step 308, the loaded software application reflects modified client environment(s) to the corresponding object server, wherein processing associated with the communication session is effected, in step 310, based on the reflected modified client environment(s) and communication between the session server and corresponding object server.

In the preferred embodiment, the client environment(s) is reflected using one or more semaphore flags. In one embodiment, a plurality of semaphore flags are used, wherein each flag is represented via a 16-bit masked constant that triggers a corresponding action. For example, a semaphore flag could be represented by the 16-bit value—00000000:00000001, which corresponds to the action command—OPEN. Similarly, another semaphore flag could be represented by the 16-bit value—00000000:00000010, which corresponds to the action command—CLOSE.

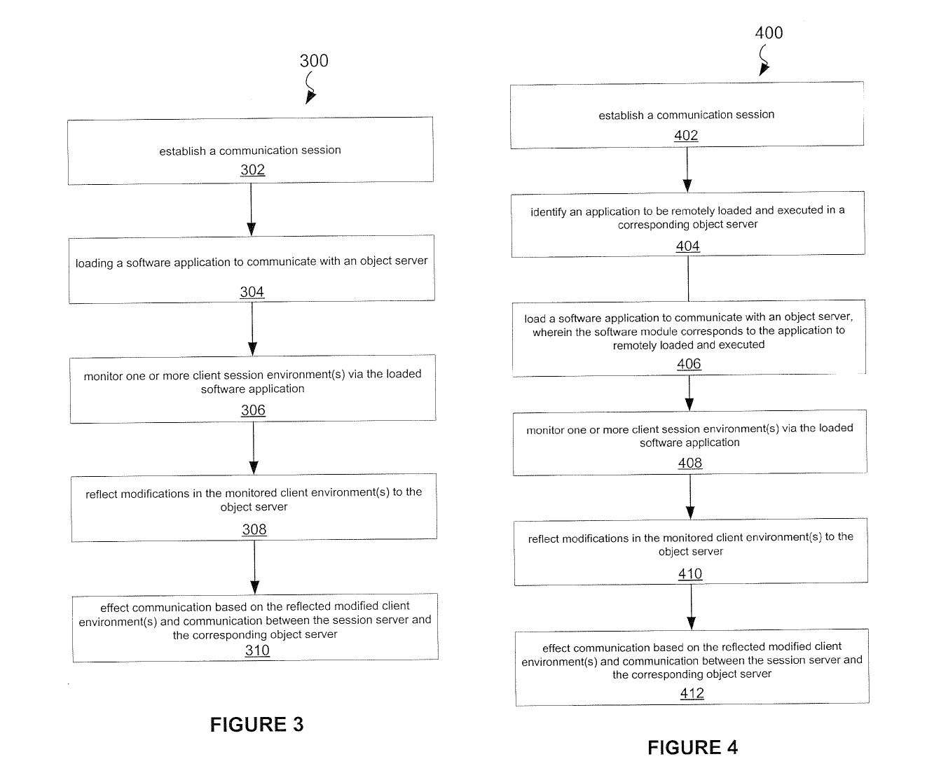

FIG. 4 illustrates another embodiment of the present invention's communication method 400 implemented in a session server for remote access to applications implemented in object servers, wherein each object server implements at least one application. In step 402, the session server establishes a communication session (e.g., a VPN session) with a client (e.g., a web browser such as Internet Explorer™, Netscape™, Mozila™, etc.). In step 404, the session server identifies at least one application to be remotely loaded and executed in a corresponding object server and, in step 406, the session server loads an appropriate software module to communicate with corresponding object server, wherein the software module corresponds to at least one application to be remotely loaded and executed.

Next, in step 408, the session server monitors modifications to at least one client environment via the loaded software module and, in step 410, the session server reflects modifications in the client environment(s) to the corresponding object server. In step 412, processing associated with the communication session is effected based on reflected modifications in the client environment and communication between the session server and the corresponding object server.

In the preferred embodiment, the client environment(s) is reflected using one or more semaphore flags.

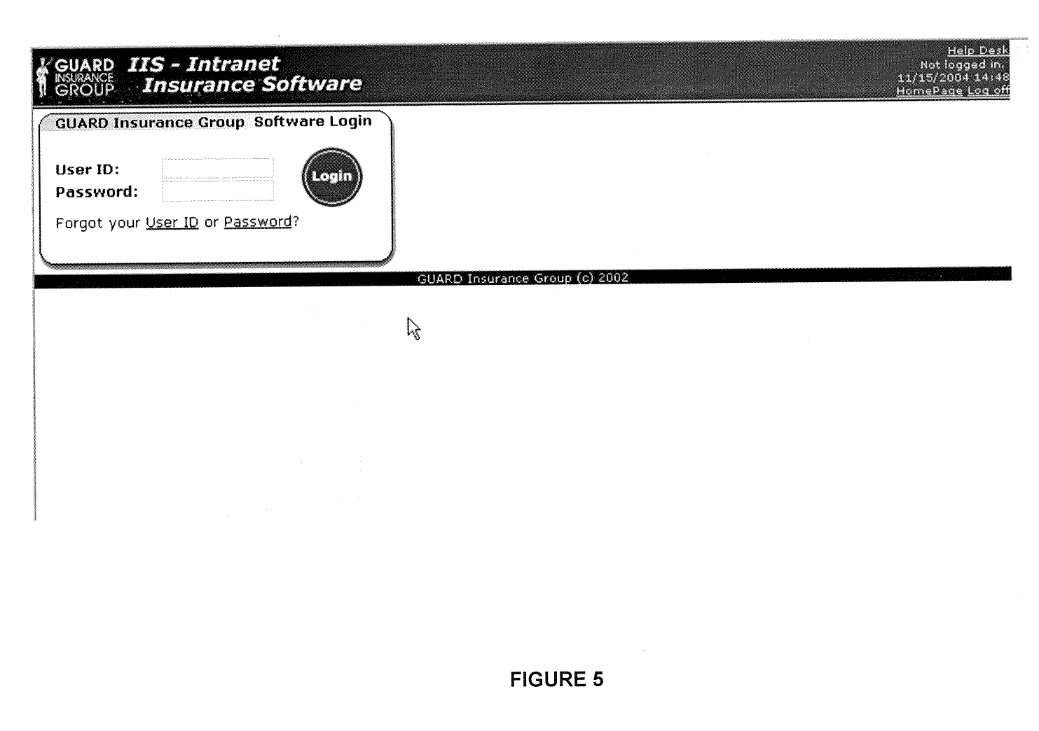

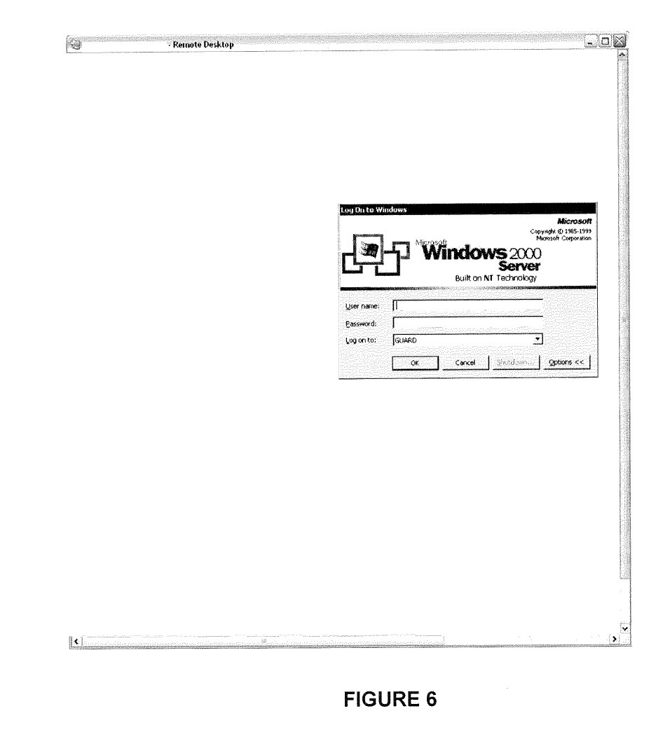

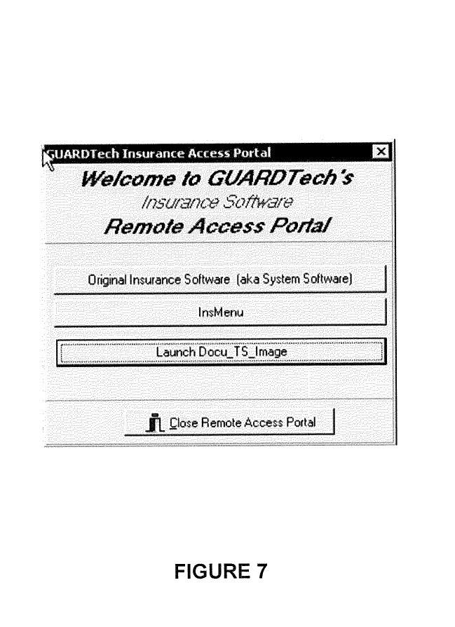

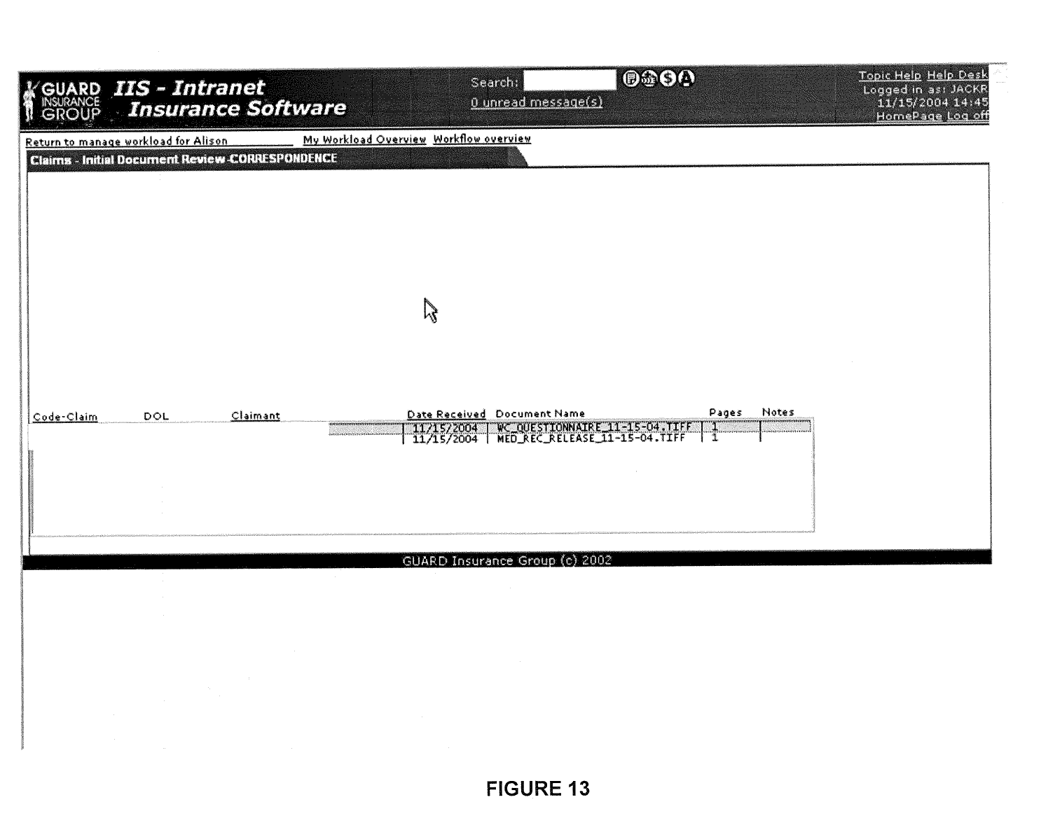

FIGS. 5-15 illustrate various screenshots of one implementation of the present invention's system and method for remote access to applications implemented in object servers. First, an authorized user establishes a virtual private network (VPN) session with a session server. Next, as shown in FIG. 5, an initial login screen is presented to the user via a client (such as a browser). An authorized user then logs into his/her account using the login page. Similarly, an authorized user opens a remote desktop connection via logging into the session server via a login screen shown in FIG. 6. After, logging into the session server, an access portal application is rendered to the user as shown in FIG. 7. The user then clicks on a choice (for example, a user can click on the choice—“Launch Docu_TS_Image”) to launch the appropriate application in the session server.

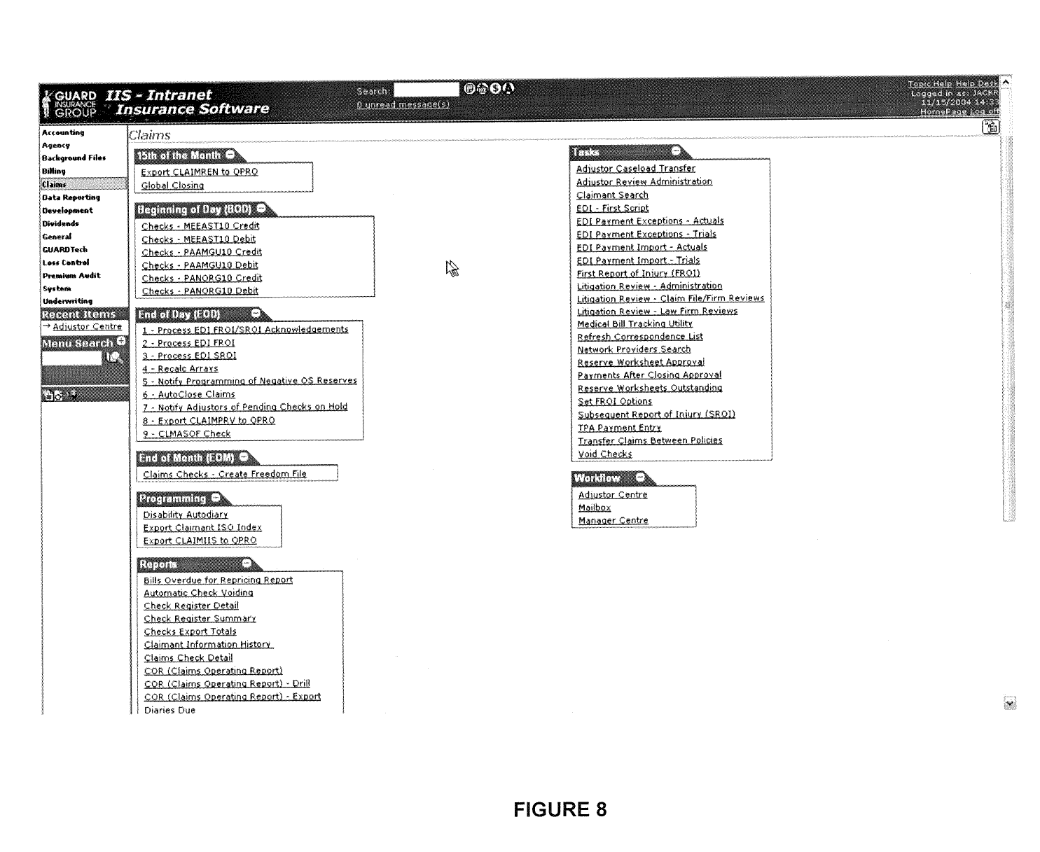

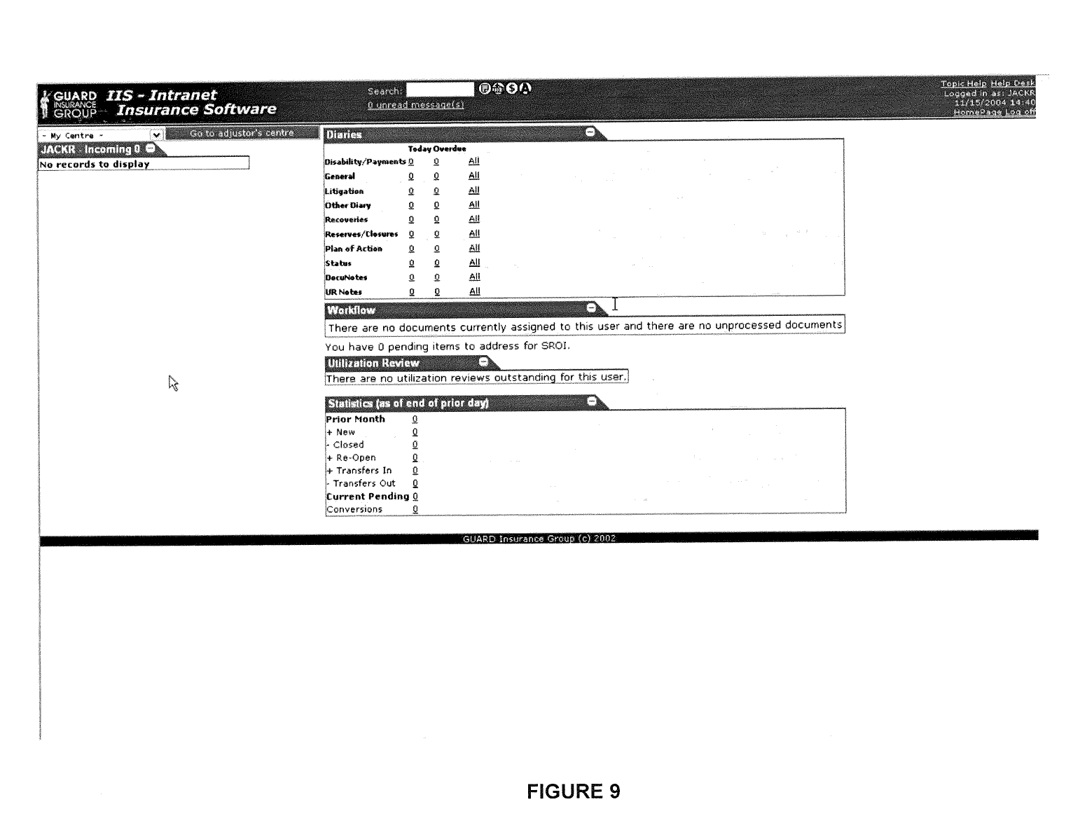

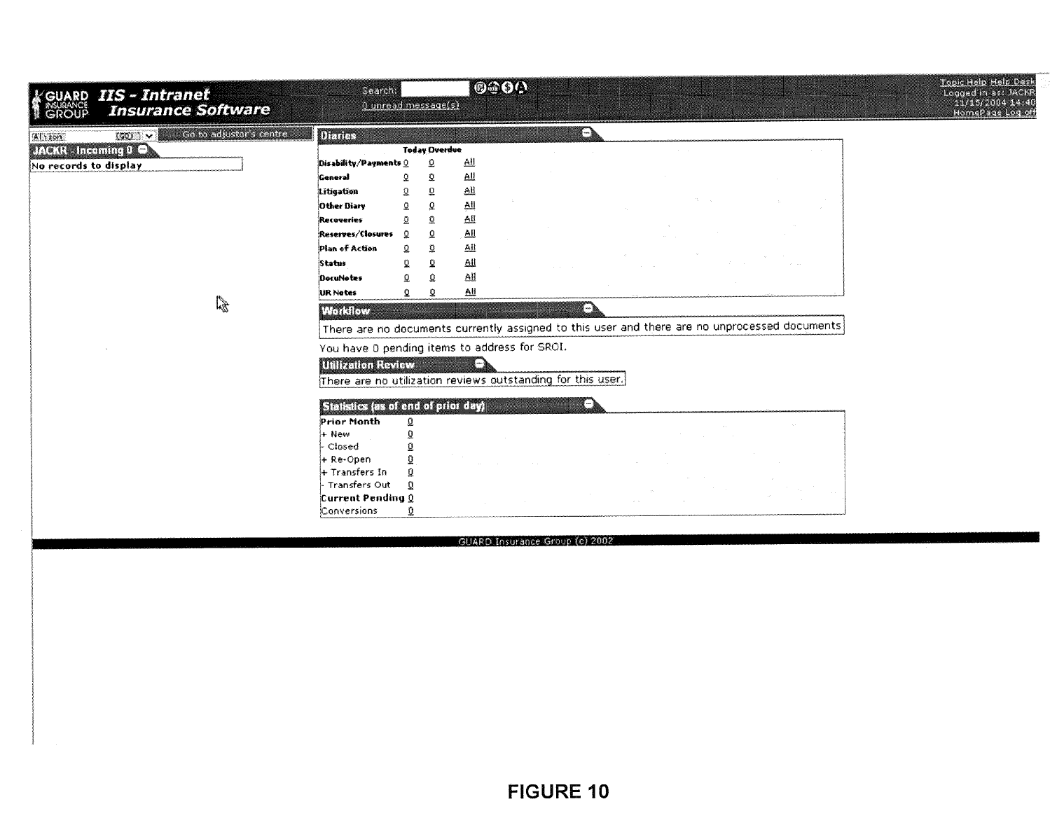

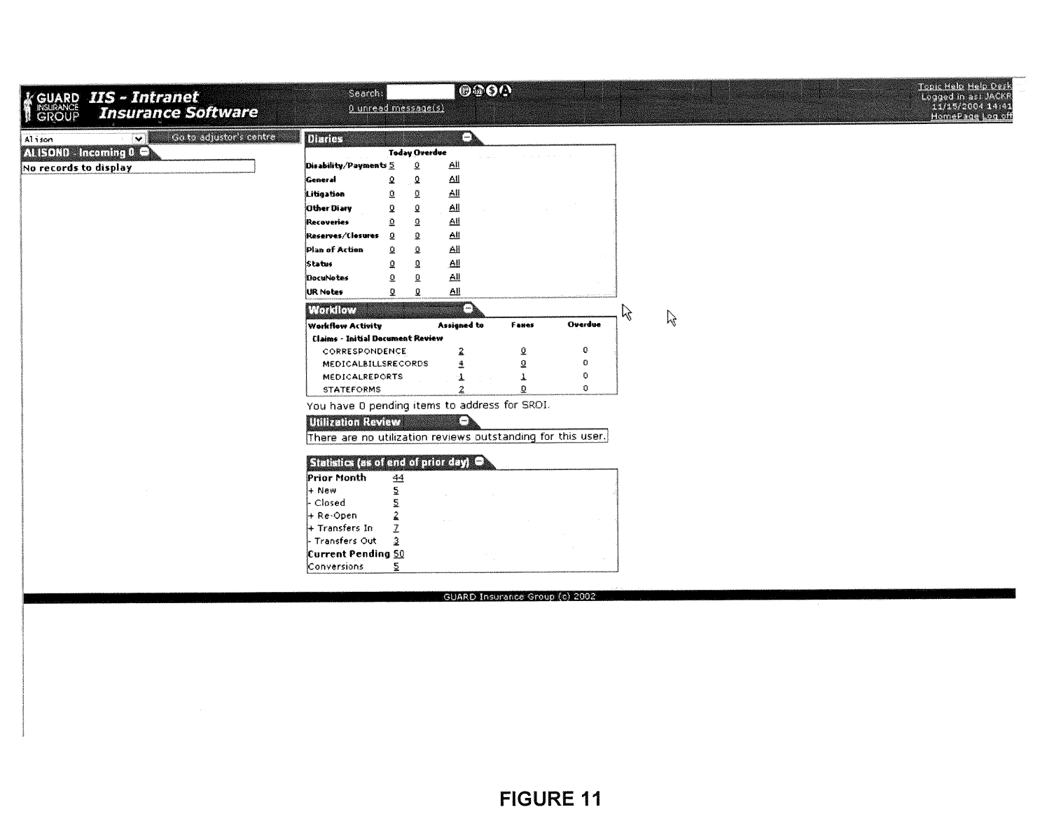

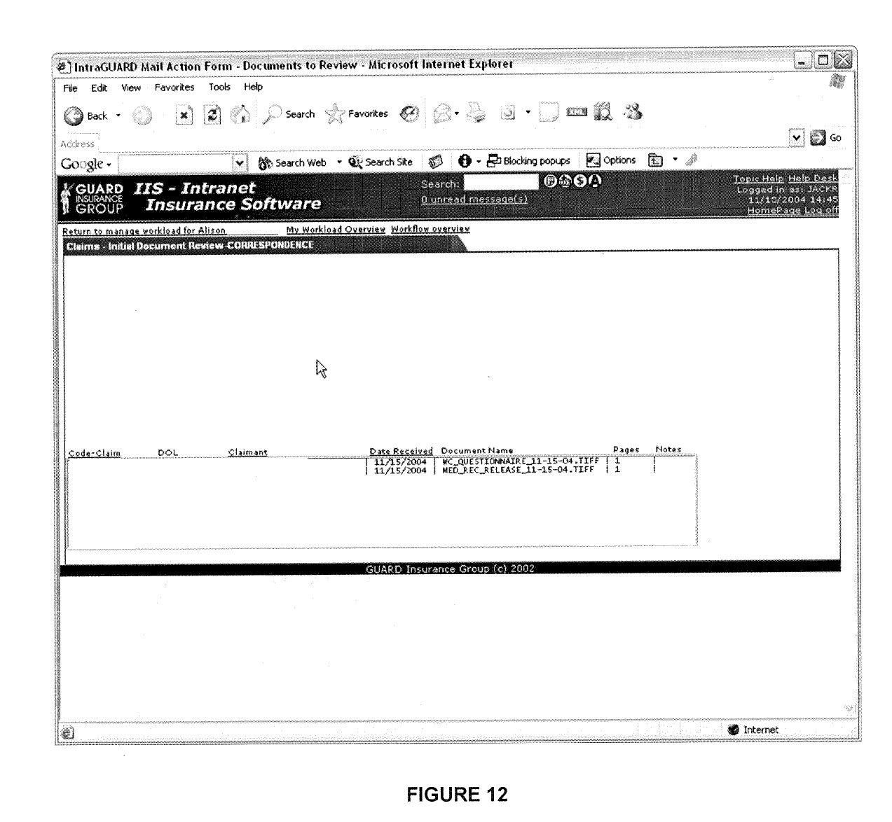

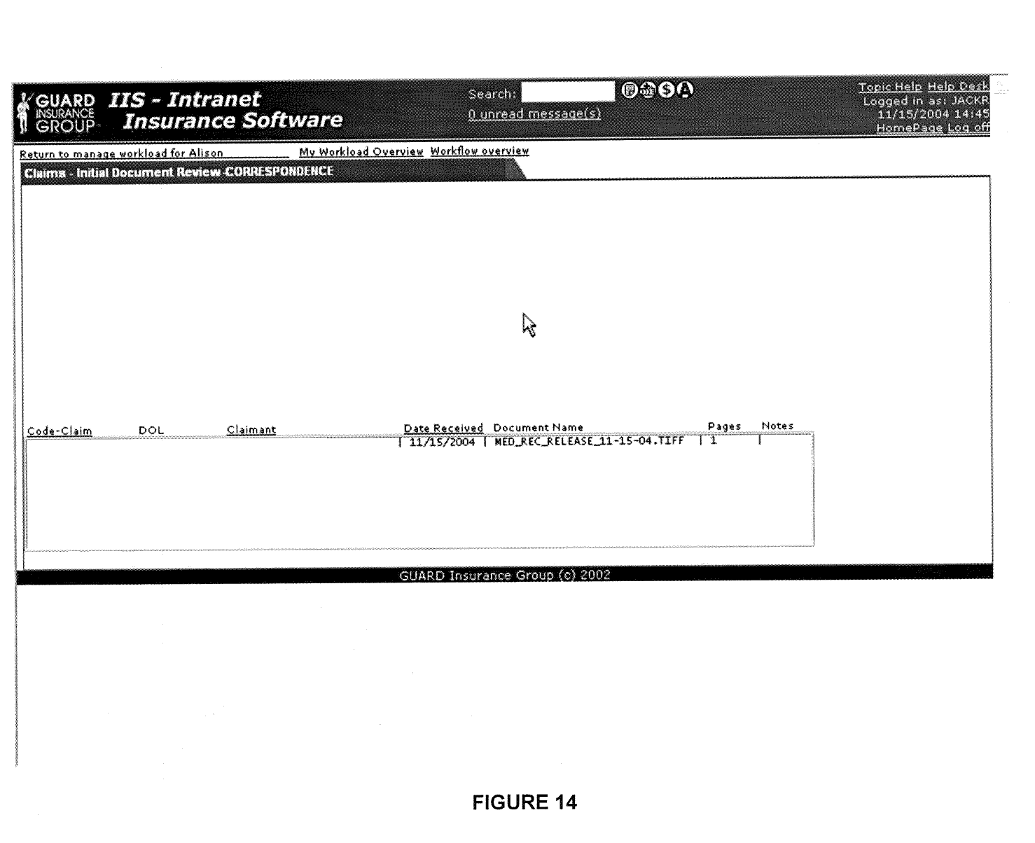

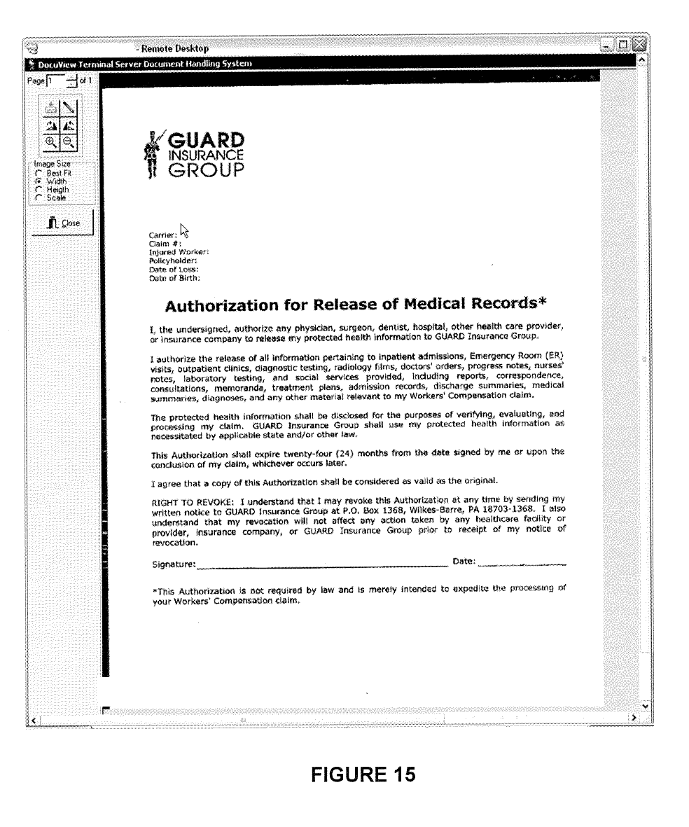

FIG. 8 illustrates a sample screenshot after an authorized user logs into his/her account via the login of FIG. 5. In this example, the user clicks on “Adjustor Centre” (of FIG. 8) to view a particular workflow as shown in FIG. 9. FIG. 10 illustrates the ability to pick and view another user's “Adjustor Centre”. FIG. 11 shows a sample “Adjustor Centre”, wherein a user can click on various workflow items (such as entries for “Correspondence”, “MedicalBillsRecords”, MedicalReports”, or “StateForms”. Clicking on each of these workflow entries launches appropriate software in the session server to communicate with appropriate object server implementing the workflow entry clicked. For example, when the user clicks on the entry corresponding to item—“Correspondence” and item13 “assigned to”, the application shows specific correspondence items (such as the two items shown in FIG. 12-14). When the user further selects and clicks on a specific item of “Correspondence” as in FIG. 14, the client environment is changed and the change is reflected by the session server to the appropriate object server (e.g., the object server implementing the DocuView application), which responds by rendering data to the client (e.g., browser), as shown in FIG. 15.

Additionally, the present invention provides for an article of manufacture comprising computer readable program code contained within implementing one or more modules to effect a novel communication method. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for working in conjunction with a computer to: (a) establish a communication session with a client; (b) load at least one software application among a plurality of software applications to communicate with at least one object server; (c) monitor one or more client session environments via said loaded at least one software application; (d) reflect said modified client environment(s) to said at least one object server, and wherein processing associated with said communication session is effected based on said reflected modified client environment(s) and communication between said session server and corresponding object server.

Conclusion

A system and method has been shown in the above embodiments for the effective implementation of a remote communication system and method implementing a session server and one or more object servers. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of graphics or object-oriented programming.

What is claimed is:

1. A remote communication method implemented in a session server comprising the steps of:
(a) establishing a communication session with a client;
(b) loading at least one software application among a plurality of software applications to communicate with at least one object server;
(c) monitoring one or more client session environments via at least one said loaded software application;
(d) reflecting said modified client environment(s) to said at least one object server, and
wherein processing associated with said communication session is effected based on said reflected modified client environment(s) and communication between said session server and corresponding object server.

2. A remote communication method implemented in a session server as per claim 1, wherein said client environment(s) is reflected using one or more semaphore flags.

3. A remote communication method implemented in a session server as per claim 1, wherein said communication session is established over a virtual private network (VPN) session, LAN or WAN.

4. A remote communication method implemented in a session server as per claim 1, wherein said client is a web browser.

5. A remote communication method implemented in a session server as per claim 1, wherein said session server is a terminal server.

6. A remote communication method implemented in a session server as per claim 1, wherein communications between said client and said session server is via the remote desktop protocol (RDP).

7. A remote communication method implemented in a session server as per claim 1, wherein communications between said client and said session server is over any of, or a combination of, the following networks: a local area network (LAN), a wide area network (WAN), or the Internet.

8. A communication method implemented in a session server for remote access to applications implemented in object servers, each object server implementing an application, said method comprising the steps of:
(a) establishing a communication session with a client;
(b) identifying at least one application to be remotely loaded and executed in a corresponding object server;
(c) loading a software module to communicate with corresponding object server of (b), said software module corresponding to said at least one application to be remotely loaded and executed;
(d) monitoring modifications to at least one client environment via said software module of (c);
(e) reflecting modifications in at least one client environment to said corresponding object server of (b); and
wherein processing associated with said communication session is effected based on said reflected modifications in said at least one client environment and communication between said session server and said corresponding object server of (b).

9. A communication method implemented in a session server for remote access to applications implemented in object servers, as per claim 8, wherein said client environment(s) is reflected using one or more semaphore flags.

10. A communication method implemented in a session server for remote access to applications implemented in object servers, as per claim 8, wherein said communication session is established over a virtual private network (VPN) session.

11. A communication method implemented in a session server for remote access to applications implemented in object servers, as per claim 8, wherein said client is a web browser.

12. A communication method implemented in a session server for remote access to applications implemented in object servers, as per claim 8, wherein said session server is a terminal server.

13. A communication method implemented in a session server for remote access to applications implemented in object servers, as per claim 8, wherein communications between said client and said session server is via the remote desktop protocol (RDP).

14. A communication method implemented in a session server for remote access to applications implemented in object servers, as per claim 8, wherein communications between said client and said session server is over any of, or a combination of, the following networks: a local area network (LAN), a wide area network (WAN), or the Internet.

15. A communication system providing access to remotely controllable applications comprising:
(a) one or more object servers, each object server associated with at least one remotely controllable application, with processing associated with said remotely controllable application affected by reflected modifications in client environments;
(b) a session server storing one or more software modules, each software module capable of monitoring modifications to at least one client environment and communicating with at least one object server to reflect modifications; and said session server establishing a communication session with one or more clients, identifying at least one remotely controllable application associated with said communication session, loading a software module corresponding to identified remotely controllable application to communicate with corresponding object server, monitoring modifications to client environment via said loaded software module, and reflecting modifications in said client environment to said corresponding object server.

16. A communication system providing access to remotely controllable applications, as per claim 15, wherein said client environment(s) is reflected using one or more semaphore flags.

17. A communication system providing access to remotely controllable applications, as per claim 15, wherein said communication session is established over a virtual private network (VPN) session.

18. A communication system providing access to remotely controllable applications, as per claim 15, wherein said client is a web browser.

19. A communication system providing access to remotely controllable applications, as per claim 15, wherein said session server is a terminal server.

20. A communication system providing access to remotely controllable applications, as per claim 15, wherein communications between said client and said session server is via the remote desktop protocol (RDP).

21. A communication system providing access to remotely controllable applications, as per claim 15, wherein communications between said client and said session server is over any of, or a combination of, the following networks: a local area network (LAN), a wide area network (WAN), or the Internet.

22. An article of manufacture comprising a computer usable medium having computer readable program code embodied therein to work in conjunction with a computer to implement a remote communication method, said medium comprising the steps of:
(a) computer readable program code working in conjunction with said computer to establish a communication session with a client;
(b) computer readable program code working in conjunction with said computer to load at least one software application among a plurality of software applications to communicate with at least one object server;
(c) computer readable program code working in conjunction with said computer to monitor one or more client session environments via said loaded at least one software application;
(d) computer readable program code working in conjunction with said computer to reflect said modified client environment(s) to said at least one object server, and
wherein processing associated with said communication session is effected based on said reflected modified client environment(s) and communication between said session server and corresponding object server.

23. An article of manufacture comprising a computer usable medium having computer readable program code embodied therein to work in conjunction with a computer to implement a remote communication method, as per claim 22, wherein said client environment(s) is reflected using one or more semaphore flags.

24. An article of manufacture comprising a computer usable medium having computer readable program code embodied therein to work in conjunction with a computer to implement a communication method for remote access to applications implemented in object servers, each object server implementing an application, said medium comprising:
(a) computer readable program code working in conjunction with said computer to establish a communication session with a client;
(b) computer readable program code working in conjunction with said computer to identify at least one application to be remotely loaded and executed in a corresponding object server;
(c) computer readable program code working in conjunction with said computer to load a software module to communicate with corresponding object server of (b), said software module corresponding to at least one application to be remotely loaded and executed;
(d) computer readable program code working in conjunction with said computer to monitor modifications to at least one client environment via said software module of (c);
(e) computer readable program code working in conjunction with said computer to reflect modifications in said at least one client environment to said corresponding object server of (b); and
wherein processing associated with said communication session is effected based on said reflected modifications in said at least one client environment and communication between said session server and said corresponding object server of (b).

25. An article of manufacture comprising a computer usable medium having computer readable program code embodied therein to work in conjunction with a computer to implement a remote communication method, as per claim 24, wherein said client environment(s) is reflected using one or more semaphore flags.
